(19) United States
(12) Patent Application Publication
(10) Pub. No.: US 2026/0100407 A1
(43) Pub. Date: Apr. 9, 2026

(54) CATHODE ACTIVE MATERIAL FOR LITHIUM SECONDARY BATTERY AND LITHIUM SECONDARY BATTERY INCLUDING THE SAME

(71) Applicant: SK ON CO., LTD., Seoul (KR)

(72) Inventors: Jae Ram KIM, Daejeon (KR); Sang Won BAE, Daejeon (KR); Jae Yeong LEE, Daejeon (KR); So Hyun PARK, Daejeon (KR); Ji Hee BAE, Daejeon (KR); Jeong Seok YEON, Daejeon (KR)

(21) Appl. No.: 19/342,666

(22) Filed: Sep. 29, 2025

(30) Foreign Application Priority Data
Oct. 8, 2024 (KR) 10-2024-0136754

(51) Int. Cl. H01M 10/0525; H01M 4/02; H01M 4/131; H01M 4/525

(52) U.S. Cl. CPC H01M 10/0525; H01M 4/131; H01M 4/525; H01M 2004/021; H01M 2004/028

(57) ABSTRACT

A cathode active material for a lithium secondary battery according to embodiments of the present disclosure includes first lithium-transition metal oxide particles containing nickel and having a single particle form, and second lithium-transition metal oxide particles including small-sized lithium-transition metal oxide particles and large-sized lithium-transition metal oxide particles and having a bi-modal distribution. The energy density, cycle life properties, and storage properties of the lithium secondary battery may be improved.

### CROSS-REFERENCE TO RELATED APPLICATIONS

This application claims priority under 35 U.S.C. § 119 to Korean Patent Application No. 10-2024-0136754, filed on Oct. 8, 2024, the disclosure of which is incorporated herein by reference in its entirety.

### BACKGROUND OF THE INVENTION

### 1. Field of the Invention

The disclosure of the present application relates to a cathode active material for a lithium secondary battery and a lithium secondary battery including the same. More specifically, the present disclosure relates to a cathode active material for a lithium secondary battery that includes particles having a bi-modal distribution and a lithium secondary battery including the cathode active material.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric vehicles and hybrid vehicles.

Examples of secondary batteries may include a lithium secondary battery, a nickel-cadmium battery, and a nickel-hydrogen battery. Among these, lithium secondary batteries are actively researched and developed due to their high operating voltage, high energy density per unit weight, and advantages in charging speed and weight reduction.

The lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

As a cathode active material for a lithium secondary battery, particles having a bi-modal distribution, which include cathode active materials with different particle size distributions, may be used. As the application range of lithium secondary batteries expands, longer cycle life, higher capacity and higher energy density are required. The cathode active material having the bi-modal distribution can improve energy density, but may exhibit degraded output properties, high-temperature performance and cycle life properties.

### SUMMARY OF THE INVENTION

According to an aspect of the present disclosure, a cathode active material for a lithium secondary battery with improved electrical properties and cycle life properties may be provided.

According to another aspect of the present disclosure, a lithium secondary battery with improved electrical properties and cycle life properties may be provided.

A cathode active material for a lithium secondary battery according to exemplary embodiments includes: first lithium-transition metal oxide particles containing nickel and having a single particle form; and second lithium-transition metal oxide particles including small-sized lithium-transition metal oxide particles and large-sized lithium-transition metal oxide particles, the second lithium-transition metal oxide particles having a bi-modal distribution.

According to exemplary embodiments, the ratio of the median particle diameter (D50) of the small-sized lithium-transition metal oxide particles to the median particle diameter (D50) of the large-sized lithium-transition metal oxide particles may be 0.08 to 0.35.

According to exemplary embodiments, the small-sized lithium-transition metal oxide particles may have a median particle diameter (D50) of 1 μm to 5 μm.

According to exemplary embodiments, the large-sized lithium-transition metal oxide particles may have a median particle diameter (D50) of 7 μm to 25 μm.

According to exemplary embodiments, the small-sized lithium-transition metal oxide particles may have a median particle diameter (D50) of 2 μm to 4 μm, and the large-sized lithium-transition metal oxide particles may have a median particle diameter (D50) of 13 μm to 20 μm.

According to exemplary embodiments, the first lithium-transition metal oxide particles may have a median particle diameter (D50) of 1 μm to 10 μm.

According to exemplary embodiments, the first lithium-transition metal oxide particles may have a median particle diameter (D50) of 2 μm to 4 μm.

According to exemplary embodiments, the first lithium-transition metal oxide particles may have a uni-modal distribution.

According to exemplary embodiments, the median particle diameter (D50) of the small-sized lithium-transition metal oxide particles may be smaller than the median particle diameter (D50) of the first lithium-transition metal oxide particles.

According to exemplary embodiments, the weight ratio of the second lithium-transition metal oxide particles to the first lithium-transition metal oxide particles may be 2 or more.

According to exemplary embodiments, the weight ratio of the small-sized lithium-transition metal oxide particles to the large-sized lithium-transition metal oxide particles in the second lithium-transition metal oxide particles may be 0.15 to 0.75.

According to exemplary embodiments, the first lithium-transition metal oxide particles, the large-sized lithium-transition metal oxide particles, and the small-sized lithium-transition metal oxide particles may each independently include nickel, manganese and cobalt.

According to exemplary embodiments, the first lithium-transition metal oxide particles, the large-sized lithium-transition metal oxide particles, and the small-sized lithium-transition metal oxide particles may each independently have a composition represented by Formula 1 below.

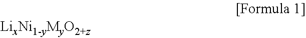

In Formula 1, 0.9≤x≤1.1, 0≤y≤0.7, −0.1≤z≤0.1, M is one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Ba.

According to exemplary embodiments, the molar fraction of nickel among metals excluding lithium in the first lithium-transition metal oxide particles, the large-sized lithium-transition metal oxide particles and the small-sized lithium-transition metal oxide particles may be 0.8 or more.

According to exemplary embodiments, the large-sized lithium-transition metal oxide particles and the small-sized lithium-transition metal oxide particles may each independently have a secondary particle form.

A lithium secondary battery according to exemplary embodiments includes: a cathode including the cathode active material for a lithium secondary battery; and an anode disposed opposite to the cathode.

The cathode active material for a lithium secondary battery according to an embodiment of the present disclosure may have improved stability and enhanced cycle life and storage properties of the lithium secondary battery.

The cathode active material for a lithium secondary battery according to the present disclosure and the lithium secondary battery including the same may be widely applied in green technology fields, such as electric vehicles, battery charging stations, as well as solar power generation, wind power generation, and the like, which use the batteries. The cathode active material for a lithium secondary battery according to the present disclosure and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating a cathode active material layer including a cathode active material according to exemplary embodiments;

FIGS. 2 and 3 are schematic cross-sectional views illustrating a lithium secondary battery according to exemplary embodiments; and

FIG. 4 is a graph showing the results of particle size analysis of each of first and second lithium-transition metal oxide particles according to an exemplary embodiment.

### DETAILED DESCRIPTION OF THE INVENTION

Examples of the present disclosure provide a cathode active material for a lithium secondary battery (hereinafter, also abbreviated as “cathode active material”) including first lithium-transition metal oxide particles having a single particle form and second lithium-transition metal oxide particles having a bi-modal distribution. In addition, a lithium secondary battery (hereinafter, also abbreviated as “secondary battery”) including the cathode active material for a lithium secondary battery is provided.

As used herein, the term “median particle diameter,” “D50,” or “average particle diameter (D50)” may refer to the particle diameter at which the cumulative volume percentage in the particle size distribution, obtained based on particle volume, reaches 50%.

The term “single particle form” as used herein is used, for example, to exclude secondary particles formed by aggregation of a plurality of primary particles. For example, in the first lithium-transition metal oxide particles described below, it may mean excluding secondary particles formed by assembling or agglomerating primary particles (e.g., more than 10, at least 20, at least 30, at least 40, or at least 50) to form a substantially single particle. However, the single particle form does not exclude a case where 2 to 10 single particles are attached or adhered to each other to form a substantially monolithic shape (e.g., a structure converted into a single particle).

The term “bi-modal” as used herein may refer to a distribution having two different modes. For example, two distinct peaks may be observed in particle size analysis results of lithium-transition metal oxide particles having a bi-modal distribution.

The term “uni-modal” as used herein may refer to a distribution having one mode. For example, a single peak may be observed in particle size analysis results of lithium-transition metal oxide particles having a uni-modal distribution.

Hereinafter, embodiments of the present disclosure will be described in detail with reference to the drawings. However, the embodiments are merely illustrative, and the present disclosure is not limited to the specific embodiments described as examples.

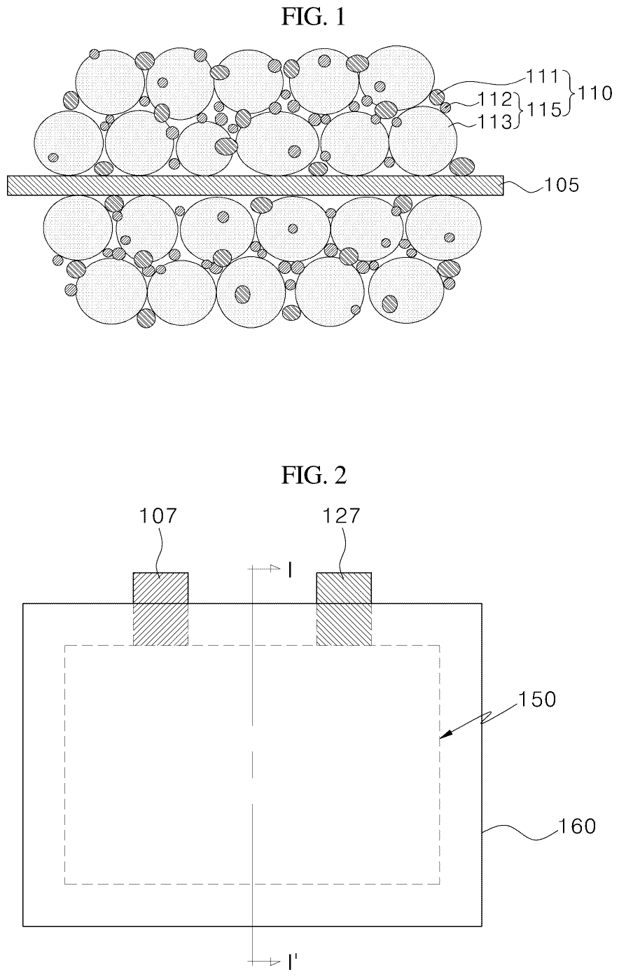

FIG. 1 is a schematic cross-sectional view illustrating a cathode active material layer including a cathode active material according to exemplary embodiments.

Referring to FIG. 1, a cathode active material layer 110 including the cathode active material may be formed on at least one surface of a cathode current collector 105.

The cathode current collector 105 may include stainless steel, nickel, aluminum, titanium, copper, or an alloy thereof. The cathode current collector 105 may also include aluminum or stainless steel having a surface treated with carbon, nickel, titanium, copper or silver. For example, the cathode current collector 105 may have a thickness of 10 μm to 50 μm.

The cathode active material layer 110 may include first lithium-transition metal oxide particles 111 having a single particle form. Further, the cathode active material layer 110 may include second lithium-transition metal oxide particles 115 having a bi-modal distribution, including the small-sized lithium-transition metal oxide particles 112 and the large-sized lithium-transition metal oxide particles 113.

By using the first lithium-transition metal oxide particles 111 together with the second lithium-transition metal oxide particles 115, the cycle life properties of the lithium secondary battery may be improved.

According to exemplary embodiments, the first lithium-transition metal oxide particles 111 may have a single particle form.

For example, the first lithium-transition metal oxide particles 111 may include a structure in which a plurality of single particles are merged into a single body to form a single particle.

For example, the first lithium-transition metal oxide particles 111 may have a granular or spherical single-particle form.

As described above, the mechanical and thermal stability of the cathode active material layer including the first lithium-transition metal oxide particles 111 having a single particle form may be further improved.

According to exemplary embodiments, the first lithium-transition metal oxide particles may have a uni-modal distribution.

According to exemplary embodiments, the first lithium-transition metal oxide particles 111 may include nickel.

In some embodiments, the first lithium-transition metal oxide particles 111 may have a composition represented by Formula 1 below. For example, the first lithium-transition metal oxide particles 111 may include a layered structure or a crystal structure represented by Formula 1 below.

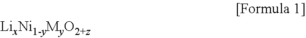

In Formula 1, x, y and z may satisfy 0.95≤x≤1.1, 0≤y≤0.7, and −0.1≤z≤0.1, and M is one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Ba.

According to exemplary embodiments, the first lithium-transition metal oxide particles 111 may include nickel, cobalt and manganese. For example, the cobalt and/or manganese may be provided as main active element of the first lithium-transition metal oxide particles 111 together with nickel.

According to exemplary embodiments, the molar fraction of nickel among metals excluding lithium in the first lithium-transition metal oxide particles 111 may be 0.8 or more. In some embodiments, the molar fraction of nickel among metals excluding lithium in the first lithium-transition metal oxide particles 111 may be 0.85 or more, 0.86 or more, 0.87 or more, or 0.88 or more.

In some embodiments, the molar fraction of nickel based on the total molar amount of nickel, cobalt and manganese may be 0.85 or more, 0.86 or more, 0.87 or more, or 0.88 or more.

For example, the molar fraction of nickel based on the total molar amount of nickel, cobalt and manganese may be 0.85 to 0.99, 0.86 to 0.98, 0.87 to 0.96, or 0.88 to 0.95.

Within the above nickel content range, a high-capacity cathode and a high-capacity lithium secondary battery may be more efficiently achieved.

It should be understood that Formula 1 is provided to express the bonding relationship between the main active elements, and is a formula encompassing the introduction and substitution of additional elements.

For example, the first lithium-transition metal oxide particles 111 may further include auxiliary elements to enhance the chemical stability of the layered structure or crystal structure.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra and P. The auxiliary element may serve as an auxiliary active element which contributes to the capacity/output activity of the cathode active material together with Co or Mn, such as Al.

The first lithium-transition metal oxide particles 111 may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

In some embodiments, the first lithium-transition metal oxide particles 111 may include a layered structure or a crystal structure represented by Formula 1-1 below.

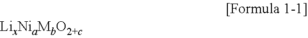

In Formula 1-1, x, a, b and c may satisfy 0.9≤x≤1.2, 0.6≤a≤0.99, 0.01≤b≤0.4, and −0.5≤c≤0.1. As described above, M may include Co, Mn and/or Al.

The median particle diameter (D50) of the first lithium-transition metal oxide particles 111 may be controlled to improve the cycle life properties of the lithium secondary battery.

According to exemplary embodiments, the first lithium-transition metal oxide particles 111 may have a median particle diameter (D50) of 1 μm to 10 μm.

In some embodiments, the first lithium-transition metal oxide particles may have a median particle diameter (D50) of 1μ m to 5 μm, 1.5μ m to 4.5 μm, 1.5μ m to 4 μm, or 2 μm to 4μ m.

In some embodiments, the median particle diameter (D50) of the first lithium-transition metal oxide particles 111 may be greater than that of the small-sized lithium-transition metal oxide particles 112.

However, the particle diameters of the first lithium-transition metal oxide particles 111 and those of the small-sized lithium-transition metal oxide particles 112 are compared based on D50, and some of the first lithium-transition metal oxide particles 111 may have particle diameters greater than those of the small-sized lithium-transition metal oxide particles 112.

Within the above particle diameter range of the first lithium-transition metal oxide particles 111, cracking between the second lithium-transition metal oxide particles 115 during fast charge and discharge may be more effectively suppressed. Therefore, gas generation inside the lithium secondary battery may be reduced, cracking may be suppressed, and the cycle life properties of the lithium secondary battery during fast charge and discharge may be further improved.

According to exemplary embodiments, the crystal size D(104) of the first lithium-transition metal oxide particles 111 on the (104) plane may be 200 nm or more.

The crystal size D(104) on the (104) plane may be defined by Equation 1 below.

$$L = \frac{K λ}{βcosθ} \qquad [ Equation 1 ]$$

In Equation 1, L represents the crystal grain size (nm), λ represents the X-ray wavelength (nm), β represents the full width at half maximum (rad) of the corresponding peak, and θ represents the diffraction angle (rad).

According to some embodiments, the D(104) of the first lithium-transition metal oxide particles 111 may be 200 nm to 400 nm, 240 nm to 370 nm, 250 nm to 350 nm, or 260 nm to 340 nm.

The first lithium-transition metal oxide particles having the D(104) value within the above range may exhibit a reduced volume expansion rate during fast charge and discharge, thereby further improving the capacity retention under fast charge of the lithium secondary battery.

According to exemplary embodiments, the second lithium-transition metal oxide particles 115 may include the small-sized lithium-transition metal oxide particles 112 and the large-sized lithium-transition metal oxide particles 113.

According to exemplary embodiments, the small-sized lithium-transition metal oxide particles 112 and the large-sized lithium-transition metal oxide particles 113 may have a single particle form or a secondary particle form formed by agglomeration of a plurality of primary particles.

In some embodiments, the small-sized lithium-transition metal oxide particles 112 and the large-sized lithium-transition metal oxide particles 113 may have a secondary particle form. Accordingly, the ion/electron migration pathways within the active material particles may be increased, further improving the energy density of the lithium secondary battery.

According to exemplary embodiments, the small-sized lithium-transition metal oxide particles 112 and the large-sized lithium-transition metal oxide particles 113 may include a lithium-transition metal oxide.

For example, the lithium-transition metal oxide may include a lithium-transition metal oxide such as lithium cobalt oxide (LiCoO₂), lithium manganese oxide (LiMn₂O₄), lithium nickel oxide (LiNiO₂), or a lithium iron phosphate (LFP)-based cathode active material, or a lithium-transition metal oxide in which a portion of these transition metals is substituted with another transition metal.

For example, the lithium-transition metal oxide may include nickel (Ni) and at least one selected from the group consisting of cobalt (Co) and manganese (Mn). For example, the lithium-transition metal oxide may include an NCM-based cathode active material, a manganese (Mn)-rich cathode active material, or a lithium (Li)-rich layered oxide (LLO)/over-lithiated oxide (OLO)-based cathode active material.

According to exemplary embodiments, the lithium-transition metal oxide may have a composition represented by Formula 1 or Formula 1-1 described above. For example, the lithium-transition metal oxide may include a layered structure or a crystal structure represented by Formula 1 or Formula 1-1 described above.

For example, the lithium-transition metal oxide may have a composition or structure represented by one of Formulae 2-1 to 2-3 described below.

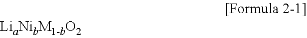

In Formula 2-1, a and b may satisfy 0.95≤a≤1.2, and b≥0.5, and Mis at least one of Na, Mg, Ca, Y, Ti, Zr, Hf, V, Nb, Ta, Cr, Mo, W, Mn, Co, Fe, Cu, Ag, Zn, B, Al, Ga, C, Si, Sn and Ba. Specifically, in Formula 2-1, a may be 0.95≤a≤1.08, and b may be 0.6 or more, 0.8 or more, greater than 0.8, 0.9 or more, or 0.98 or more. Specifically, in Formula 2-1, M may include Co, Mn or Al, and more specifically, M may include Co and Mn, and optionally further include Al.

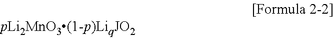

In Formula 2-2, p and q may satisfy 0<p<1, and 0.9≤q≤1.2, and J may be one or more elements selected from the group consisting of Mn, Ni, Co, Fe, Cr, V, Cu, Zn, Ti, Al, Mg and B.

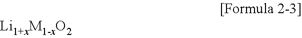

In Formula 2-3, x may be 0≤x≤0.4, and M may be at least one of Na, Mg, Ca, Y, Ti, Zr, Hf, V, Nb, Ta, Cr, Mo, W, Ni, Mn, Co, Fe, Cu, Ag, Zn, B, Al, Ga, C, Si, Sn and Ba. Specifically, in Formula 2-3, M may include Ni, Co, Mn or Al, and more specifically, may include Ni, Co and Mn, and optionally, may further include Al.

According to exemplary embodiments, the small-sized lithium-transition metal oxide particles 112 and the large-sized lithium-transition metal oxide particles 113 may include nickel.

According to exemplary embodiments, the small-sized lithium-transition metal oxide particles 112 or the large-sized lithium-transition metal oxide particles 113 may further include manganese or cobalt.

For example, the cobalt and/or manganese may be provided as the main active elements of the small-sized lithium-transition metal oxide particles 112 or the large-sized lithium-transition metal oxide particles 113 together with nickel.

According to exemplary embodiments, the molar fraction of nickel in the small-sized lithium-transition metal oxide particles 112 and the large-sized lithium-transition metal oxide particles 113 may be 0.8 or more. In some embodiments, the molar fraction of nickel among metals excluding lithium in the small-sized lithium-transition metal oxide particles 112 and the large-sized lithium-transition metal oxide particles 113 may be 0.85 or more, 0.86 or more, 0.87 or more, or 0.88 or more. For example, the molar fraction of nickel among metals excluding lithium in the small-sized lithium-transition metal oxide particles 112 and the large-sized lithium-transition metal oxide particles 113 may be 0.85 to 0.99, 0.86 to 0.98, 0.87 to 0.96, or 0.88 to 0.95.

Within the above nickel molar fraction range of the small-sized lithium-transition metal oxide particles 112 and the large-sized lithium-transition metal oxide particles 113, the capacity of the lithium secondary battery may be further increased.

In some embodiments, the small-sized lithium-transition metal oxide particles 112 and the large-sized lithium-transition metal oxide particles 113 may have a composition substantially identical to or similar to that of the first lithium-transition metal oxide particles 111. Accordingly, the output of the lithium secondary battery may be further increased.

For example, the small-sized lithium-transition metal oxide particles 112 or the large-sized lithium-transition metal oxide particles 113 may further include auxiliary elements to enhance the chemical stability of the layered structure or the crystal structure.

For example, the small-sized lithium-transition metal oxide particles 112 or the large-sized lithium-transition metal oxide particles 113 may further include a coating element or a doping element.

The auxiliary element, coating element, or doping element may include the auxiliary element, coating element, or doping element of the above-described first lithium-transition metal oxide particles 111.

According to exemplary embodiments, the small-sized lithium-transition metal oxide particles 112 may have a median particle diameter (D50) of 1 μm to 5 μm.

In some embodiments, the small-sized lithium-transition metal oxide particles 112 may have a median particle diameter (D50) of 1.5 μm to 4.5 μm, 2 μm to 4.5 μm, or 2 μm to 4 μm.

According to exemplary embodiments, the large-sized lithium-transition metal oxide particles 113 may have a median particle diameter (D50) of 7 μm to 25 μm.

In some embodiments, the large-sized lithium-transition metal oxide particles 113 may have a median particle diameter (D50) of 10 μm to 25 μm, 12μ m to 22 μm, 13 μm to 20 μm, or 13 μm to 17 μm.

Within the above median particle diameter (D50) range, the small-sized lithium-transition metal oxide particles 112 may be disposed in the voids between the large-sized lithium-transition metal oxide particles 113. Accordingly, the energy density of the cathode may be further improved, and the contact area between the cathode active material and the electrolyte may be increased.

For example, if the particle diameter of the small-sized lithium-transition metal oxide particles 112 exceeds the above range or the particle diameter of the large-sized lithium-transition metal oxide particles 113 is less than the above range, it may be more difficult for the small-sized particles to be disposed in the spaces between the large-sized lithium-transition metal oxide particles 113, and thus, the energy density of the lithium secondary battery may be reduced.

For example, if the particle diameter of the small-sized lithium-transition metal oxide particles 112 is less than the above range or the particle diameter of the large-sized lithium-transition metal oxide particles 113 is greater than the above range, the mechanical and thermal stability of the cathode active material layer 110 may be further reduced.

According to exemplary embodiments, the ratio of the median particle diameter (D50) of the small-sized lithium-transition metal oxide particles 112 to that of the large-sized lithium-transition metal oxide particles 113 may be 0.08 to 0.35.

In some embodiments, the ratio of the median particle diameter (D50) of the small-sized lithium-transition metal oxide particles 112 to that of the large-sized lithium-transition metal oxide particles 113 may be 0.12 to 0.3, 0.13 to 0.25, or 0.14 to 0.22.

Within the above particle diameter ratio range, the small-sized lithium-transition metal oxide particles 112 may be efficiently disposed in the voids between the large-sized lithium-transition metal oxide particles 113. Therefore, even if the volume of the lithium-transition metal oxide particles expands with increasing temperature, cracking may be suppressed, thereby further improving the high-temperature cycle life properties of the lithium secondary battery.

For example, if the particle diameter ratio exceeds the above range, it may be difficult for the second lithium-transition metal oxide particles 115 to have a bi-modal distribution.

According to exemplary embodiments, the median particle diameter (D50) of the small-sized lithium-transition metal oxide particles 112 may be smaller than that of the first lithium-transition metal oxide particles 111.

According to exemplary embodiments, after forming the second lithium-transition metal oxide particles 115 having a bi-modal distribution including the small-sized lithium-transition metal oxide particles 112 and the large-sized lithium-transition metal oxide particles 113, the first lithium-transition metal oxide particles 111 having a single particle form may be mixed.

For example, when the first lithium-transition metal oxide particles 111, the small-sized lithium-transition metal oxide particles 112 and the large-sized lithium-transition metal oxide particles 113 are simultaneously mixed to form the cathode active material layer 110, gas generation within the lithium secondary battery may be effectively reduced, thereby further improving the cycle life of the lithium secondary battery. In addition, the mechanical stability of the lithium secondary battery may be further improved.

The small-sized lithium-transition metal oxide particles 112 may be disposed between the large-sized lithium-transition metal oxide particles 113.

According to exemplary embodiments, the volume ratio of the small-sized lithium-transition metal oxide particles 112 to the large-sized lithium-transition metal oxide particles 113 may be 0.15 to 0.5, or 0.2 to 0.4.

According to exemplary embodiments, the weight ratio of the small-sized lithium-transition metal oxide particles 112 to the large-sized lithium-transition metal oxide particles 113 may be 0.15 to 0.75.

In some embodiments, the weight ratio of the small-sized lithium-transition metal oxide particles 112 to the large-sized lithium-transition metal oxide particles 113 may be 0.18 to 0.65, 0.2 to 0.60, or 0.2 to 0.5.

Within the above weight ratio range, the small-sized lithium-transition metal oxide particles 112 may be efficiently disposed between the large-sized lithium-transition metal oxide particles 113. Accordingly, the energy density of the lithium secondary battery may be further improved.

If the weight ratio is less than the above range, the small-sized lithium-transition metal oxide particles 112 may scatter during the cathode formation process, further reducing the energy density of the cathode active material layer.

According to exemplary embodiments, the crystal size D(104) of the second lithium-transition metal oxide particles 115 on the (104) plane may be 100 nm or less.

The crystal size D(104) on the (104) plane may be defined by Equation 1 above.

According to some embodiments, the D(104) of the second lithium-transition metal oxide particles 115 may be 10 nm to 80 nm, 15 nm to 70 nm, 20 nm to 65 nm, or 30 nm to 60 nm.

The second lithium-transition metal oxide particles having the D(104) value may further increase the contact area with lithium ions by including internal pores. Accordingly, the capacity properties and cycle life properties of the lithium secondary battery may be further improved.

According to exemplary embodiments, the weight ratio of the second lithium-transition metal oxide particles 115 to the first lithium-transition metal oxide particles 111 may be 2 or more.

In some embodiments, the weight ratio of the first lithium-transition metal oxide particles 111 to the second lithium-transition metal oxide particles 115 may be 2 to 10, 2.1 to 9.5, or 2.3 to 9.

Within the above weight ratio range, the first lithium-transition metal oxide particles 111 may be efficiently disposed in the pores, thereby further improving the thermal and mechanical stability of the For example, if the weight ratio exceeds the above range, the amount of active material in the form of secondary particles may increase, resulting in increased gas generation and reduced capacity retention. If the weight ratio is less than the above range, the initial resistance of the secondary battery may increase and the capacity may be further decreased.

For example, the cathode active material layer 110 may be prepared from a cathode slurry obtained by dispersing the lithium-transition metal oxide particles in a solvent. For example, the cathode slurry may be coated on the cathode current collector 105, followed by drying and roll-pressing to fabricate the cathode 100. The cathode slurry may further include a binder and may optionally further include a conductive material, a thickener and the like.

The binder may include, for example, an organic binder such as vinylidene fluoride-hexafluoropropylene copolymer (PVDF-co-HFP), polyvinylidene fluoride (PVDF), polyacrylonitrile, polymethylmethacrylate, or an aqueous binder such as styrene-butadiene rubber (SBR), and may be used together with a thickener such as carboxymethyl cellulose (CMC). For example, a PPC/LiTFSI-based binder may be used as a cathode binder.

The conductive material may be included to promote electron migration between the active material particles. For example, the conductive material may include carbon-based conductive materials such as graphite, carbon black, graphene, or carbon nanotubes, and/or metal-based conductive materials, including perovskite materials, such as tin, tin oxide, titanium oxide, LaSrCoO₃, and LaSrMnO₃, etc.

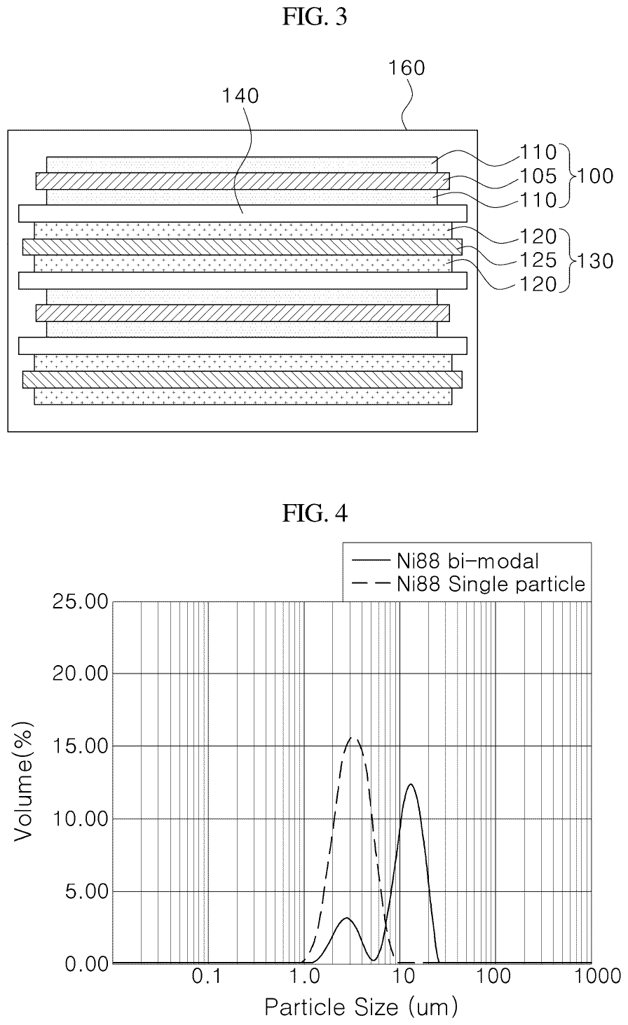

FIGS. 2 and 3 are schematic plan and cross-sectional views illustrating a lithium secondary battery according to exemplary embodiments, respectively. For example, FIG. 3 is a cross-sectional view taken along line I-I′ of FIG. 2 in the thickness direction of the battery.

Referring to FIGS. 2 and 3, the lithium secondary battery may include a cathode 100 including the above-described cathode active material, and an anode 130 disposed opposite to the cathode 100.

The cathode 100 may include the cathode active material layer 110 formed by applying a cathode active material to at least one surface of the cathode current collector 105.

The cathode active material may include a plurality of first lithium-transition metal oxide particles 111 and a plurality of second lithium-transition metal oxide particles 115. For example, the total amount of the lithium-transition metal oxide particles 111 and 115, based on the total weight of the cathode active material, may be 70 wt % or more. In some embodiments, the total amount of the lithium-transition metal oxide particles 111 and 115, based on the total weight of the cathode active material, may be 80 wt % or more, or 90 wt % or more.

In one embodiment, the cathode active material may be substantially composed of the lithium-transition metal oxide particles 111 and 115.

The anode 130 may include an anode current collector 125 and an anode active material layer 120 formed by coating an anode active material on at least one surface of the anode current collector 125.

The anode active material may include a material capable of absorbing and desorbing lithium ions. For example, carbon-based materials such as crystalline carbon, amorphous carbon, carbon composites, carbon fibers, a lithium alloy, silicon, or tin may be used as the anode active material. Examples of the amorphous carbon may include hard carbon, coke, mesocarbon microbead (MCMB) calcined at 1500° C. or lower, mesophase pitch-based carbon fiber (MPCF) or the like. Examples of the crystalline carbon may include graphite-based carbon such as natural graphite, graphitized coke, graphitized MCMB, graphitized MPCF or the like. Other elements included in the lithium alloy may include, for example, aluminum, zinc, bismuth, cadmium, antimony, silicon, lead, tin, gallium, indium or the like.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more thereof. For example, the anode current collector 125 may have a thickness of 10 μm to 50 μm.

In some embodiments, a slurry may be prepared by mixing and stirring the anode active material with a binder, a conductive material and/or a dispersant in a solvent. The slurry may be applied to at least one surface of the anode current collector, and then dried and roll-pressed to prepare the anode 130.

As the binder and conductive material, materials substantially the same as or similar to the binder and conductive material included in the cathode may be used. In some embodiments, a binder for forming the anode may include an aqueous binder such as styrene-butadiene rubber (SBR) to ensure compatibility with a carbon-based active material, and may be used together with a thickener such as carboxymethyl cellulose (CMC).

In some embodiments, a separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

According to exemplary embodiments, an electrode cell may be defined by the cathode 100, the anode 130 and the separation membrane 140, and a plurality of electrode cells may be stacked to form, for example, a jelly roll type electrode assembly 150. For example, the electrode assembly 150 may be formed by winding, stacking, z-folding, or stack-folding the separation membrane 140.

The electrode assembly may be accommodated in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent. The lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₃PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻; (FSO₂)₂N⁻; CF₃CF₂(CF₃)₂Co⁻, (CF₃SO₂)₂CH⁻, (SF₅)₃C⁻, (CF₃SO₂)₃C⁻, CF₃(CF₂)₇SO₃⁻, CF₃Co₂⁻, CH₃Co₂⁻, SCN⁻ and (CF₃CF₂SO₂)₂N⁻, etc. may be exemplified. As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato)phosphate, lithium difluorophosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIG. 3, electrode tabs (cathode tabs and anode tabs) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### EXAMPLE

### (1) Fabrication of Cathode

Li [Ni_{0.88}Co_{0.1}Mn_{0.02}]O₂ having a median particle diameter of 3.8 μm was used as the first lithium-transition metal oxide particles in the form of single particles. Li [Ni_{0.88}Co_{0.1}Mn_{0.02}]O₂ including large-sized lithium-transition metal oxide particles having a median particle diameter of 15.82 μm and small-sized lithium-transition metal oxide particles having a median particle diameter of 2.75 μm was used as the second lithium-transition metal oxide particles having a bi-modal distribution.

A slurry was prepared by mixing 98.08 wt % of a composition including first lithium-transition metal oxide particles in the form of single particles and second lithium-transition metal oxide particles having a bi-modal distribution in a weight ratio of 20:80, 0.6 wt % MWCNTs as a conductive material, 0.12 wt % CNTs as a conductive dispersant, and 1.2 wt % polyvinylidene fluoride (PVdF) as a binder. The slurry was uniformly applied to an aluminum foil having a thickness of 12 μm and vacuum-dried to fabricate a cathode for a secondary battery.

### (2) Fabrication of Anode

An anode slurry was prepared, including 85.9 wt % artificial graphite as an anode active material, 11 wt % silicon-carbon (SiC) composite particles including silicon (Si) as a silicon-based active material, 0.3 wt % single-walled carbon nanotubes (SWCNTs), 1.5 wt % styrene-butadiene rubber (SBR) as a binder, and 1.3 wt % carboxymethyl cellulose (CMC) as a thickener. The anode slurry was coated onto a copper substrate, and then dried and pressed to fabricate an anode.

### (3) Manufacture of Secondary Battery

The cathode and anode were notched to a predetermined size and stacked, with a separator (polyethylene, thickness: 15 μm) interposed between the cathode and anode to form an electrode cell, and then the tab portions of the cathode and anode were welded, respectively. The assembly of the welded cathode/separator/anode was placed into a pouch, and three sides of the pouch were sealed, leaving one side open for electrolyte injection. At this time, the portion having the electrode tab was included in the sealed part. After injecting the electrolyte through the electrolyte injection side, the remaining electrolyte injection side was also sealed, and the cell was allowed to be impregnated for 12 hours or more to manufacture a lithium secondary battery.

A solution, prepared by dissolving 1 M LiPF₆ in a mixed solvent of EC/EMC (25/75; volume ratio) and adding 1 wt % vinylene carbonate (VC), 0.5 wt % 1,3-propenesultone (PRS), and 0.5 wt % lithium bis(oxalato) borate (LiBOB), was used as the electrolyte.

Thereafter, heat press pre-charging was performed on the lithium secondary battery for 60 minutes at an average current of 0.5 C. After stabilization for 12 hours or longer, degassing was performed, followed by aging for 24 hours or more. Formation charging and discharging were then carried out (charging conditions: CC-CV 0.25 C, 4.2 V, 0.05 C cut-off; discharging conditions: CC 0.25 C, 2.5 V cut-off).

Subsequently, standard charging and discharging were performed (charging conditions: CC-CV 0.33 C, 4.2 V, 0.05 C cut-off; discharging conditions: CC 0.33 C, 2.5 V cut-off).

### Examples and Comparative Examples

Lithium secondary batteries were manufactured in the same manner as in the above example, except that the median particle diameters and contents of the first lithium-transition metal oxide particles, the large-sized lithium-transition metal oxide particles, and the small-sized lithium-transition metal oxide particles were changed according to Tables 1 and 2 below.

The particle sizes and particle size distributions of the first lithium-transition metal oxide particles, the large-sized lithium-transition metal oxide particles, and the small-sized lithium-transition metal oxide particles were analyzed using a laser diffraction particle size analyzer (Mastersizer 3000, Malvern) at a circulation rate of 65 mL/sec for 10 to 30 seconds.

TABLE 1

| | Median particle | Median particle diameter of | |
|---|---|---|---|
| | diameter of first | second lithium-transition metal | |
| | lithium-transition | oxide particles (D50, μm) | |
| | metal oxide particles | Small-sized | Large-sized |
| Classification | (D50, μm) | particles | particles |
| Example 1 | 3.8 | 2.75 | 15.82 |
| Example 2 | 4.5 | 2.75 | 15.82 |
| Example 3 | 7.1 | 2.76 | 15.80 |
| Example 4 | 3.7 | 1.53 | 15.82 |
| Example 5 | 3.6 | 3.21 | 15.83 |
| Example 6 | 3.6 | 4.19 | 15.81 |
| Example 7 | 3.6 | 2.81 | 8.1 |
| Example 8 | 3.8 | 2.75 | 12.15 |
| Example 9 | 3.8 | 2.74 | 16.38 |
| Example 10 | 3.7 | 2.76 | 17.43 |
| Example 11 | 3.8 | 2.75 | 28.41 |

TABLE 2

| | Weight ratio of first | Weight ratio of small- |
|---|---|---|
| | lithium-transition metal | sized particles to large- |
| | oxide particles to second | sized particles in the |
| | lithium-transition metal | second lithium-transition |
| Classification | oxide particles | metal oxide particles |
| Example 12 | 20:80 | 20:80 |
| Example 13 | 40:60 | 20:80 |
| Example 14 | 20:80 | 40:60 |
| Comparative | 100:0 | — |
| Example 1 | | |
| Comparative | 0:100 | 20:80 |
| Example 2 | | |
| Comparative | 20:80 | 0:100 |
| Example 3 | | |
| Comparative | 20:80 | 100:0 |
| Example 4 | | |

### Experimental Example

### (1) Measurement of Particle Size Based on Volume

The median particle diameters and particle size distributions of the first lithium-transition metal oxide particles, the large-sized lithium-transition metal oxide particles, and the small-sized lithium-transition metal oxide particles were measured using a particle size analyzer. The measurements were performed and analyzed using a laser diffraction particle size analyzer (Mastersizer 3000, Malvern) at a circulation rate of 65 mL/see for 10 to 30 seconds. The analysis results are shown in FIG. 4. In FIG. 4, the horizontal axis represents particle size on a logarithmic scale, and the vertical axis represents particle volume ratio.

As shown in FIG. 4, the first lithium-transition metal oxide particles exhibited a uni-modal distribution, while the second lithium-transition metal oxide particles exhibited a bi-modal distribution.

### (2) X-Ray Diffraction (XRD) Analysis

The first lithium-transition metal oxide particles and the second lithium-transition metal oxide particles, including large-sized lithium-transition metal oxide particles and small-sized lithium-transition metal oxide particles, were analyzed using XRD.

The crystal size on the (104) plane was calculated using Equation 1 below.

$$L = \frac{K λ}{βcosθ} \qquad [ Equation 1 ]$$

In Equation 1, L represents the crystal grain size (nm), λ represents the X-ray wavelength (nm), β represents the full width at half maximum (rad) of the corresponding peak, and θ represents the diffraction angle (rad).

Measurement results showed that the crystal size D(104) of the first lithium-transition metal oxide particles on the (104) plane according to the examples was 282±10 nm, and the crystal size D(104) of the second lithium-transition metal oxide particles on the (104) plane was 45±5 nm.

### (3) Evaluation of Fast Charging Cycle Life Properties

The lithium secondary batteries manufactured according to the examples and comparative examples were charged at step charge rates of 3.25 C/3.0 C/2.75 C/2.5 C/2.25 C/2.0 C/1.75 C/1.5 C/1.25 C/1.0 C/0.75 C/0.5 C to reach a depth of discharge (DOD) of 72% within 25 minutes, and then discharged at 1/3 C. The charging and discharging were defined as one cycle, and the fast-charging cycle life properties were evaluated by repeating the cycles. After 200 cycles with a 10-minute rest time between charge and discharge cycles, the capacity retention under fast-charging conditions for each cycle was measured.

### (4) Evaluation of High-Temperature (60° C.) Storage Properties

The lithium secondary batteries manufactured according to the examples and comparative examples were stored at 60° C. in a chamber under 100% state of charge (SOC 100) conditions. The high-temperature storage properties were evaluated by determining the time at which the lithium secondary batteries vented.

The evaluation results according to the experimental examples are shown in Table 3.

TABLE 3

| | Capacity retention under | High-temperature |
|---|---|---|
| | fast-charging conditions | storage properties |
| Classification | (200 cycles) (%) | (week) |
| Example 1 | 95.5 | 21 |
| Example 2 | 91 | 21 |
| Example 3 | 85 | 21 |
| Example 4 | 95 | 19 |
| Example 5 | 94 | 21 |
| Example 6 | 93 | 21 |
| Example 7 | 94 | 19 |
| Example 8 | 95 | 19 |
| Example 9 | 93 | 21 |
| Example 10 | 92 | 21 |
| Example 11 | 88 | 21 |
| Example 12 | 95.5 | 21 |
| Example 13 | 90 | 23 |
| Example 14 | 95 | 19 |
| Comparative Example 1 | 80 | 24 |
| Comparative Example 2 | 95.5 | 14 |
| Comparative Example 3 | 92 | 19 |
| Comparative Example 4 | 94 | 12 |

As shown in Table 3, the capacity retention and high-temperature storage properties of lithium secondary batteries including the first lithium-transition metal oxide particles and the second lithium-transition metal oxide particles were improved under fast-charging conditions.

In Example 2, where the particle diameter of the first lithium-transition metal oxide particles exceeded 5 μm, the capacity retention under fast-charging conditions was relatively reduced.

In Example 3, where the particle diameter of the first lithium-transition metal oxide particles exceeded 5 μm, the capacity retention under fast-charging conditions was relatively reduced.

In Example 11, where the large-sized lithium-transition metal oxide particles in the second lithium-transition metal oxide particles exceeded 25 μm, the capacity retention under fast-charging conditions was relatively reduced.

In Example 13, where the weight ratio of the second lithium-transition metal oxide particles to the first lithium-transition metal oxide particles was less than 2, the capacity retention under fast-charging conditions was relatively reduced.

In Comparative Example 1, which included only the first lithium-transition metal oxide particles, the capacity retention under fast-charging conditions was significantly reduced. In Comparative Example 2, which included only the second lithium-transition metal oxide particles, the high-temperature storage properties were significantly reduced.

In Comparative Example 3, where the second lithium-transition metal oxide particles did not have a bi-modal distribution and only included large-sized lithium-transition metal oxide particles, the capacity retention under fast-charging conditions and the high-temperature storage properties were reduced.

In Comparative Example 4, where the second lithium-transition metal oxide particles did not have a bi-modal distribution and included only small-sized lithium-transition metal oxide particles, the high-temperature storage properties were significantly reduced.

What is claimed is:

1. A cathode active material for a lithium secondary battery comprising:
first lithium-transition metal oxide particles containing nickel and having a single particle form; and
second lithium-transition metal oxide particles including small-sized lithium-transition metal oxide particles and large-sized lithium-transition metal oxide particles, the second lithium-transition metal oxide particles having a bi-modal distribution.

2. The cathode active material for a lithium secondary battery according to claim 1, wherein the ratio of the median particle diameter (D50) of the small-sized lithium-transition metal oxide particles to the median particle diameter (D50) of the large-sized lithium-transition metal oxide particles is 0.08 to 0.35.

3. The cathode active material for a lithium secondary battery according to claim 1, wherein the small-sized lithium-transition metal oxide particles have a median particle diameter (D50) of 1μ m to 5μ m.

4. The cathode active material for a lithium secondary battery according to claim 1, wherein the large-sized lithium-transition metal oxide particles have a median particle diameter (D50) of 7μ m to 25μ m.

5. The cathode active material for a lithium secondary battery according to claim 1, wherein the small-sized lithium-transition metal oxide particles have a median particle diameter (D50) of 2 μm to 4 μm, and the large-sized lithium-transition metal oxide particles have a median particle diameter (D50) of 13 μm to 20μ m.

6. The cathode active material for a lithium secondary battery according to claim 1, wherein the first lithium-transition metal oxide particles have a median particle diameter (D50) of 1 μm to 10 μm.

7. The cathode active material for a lithium secondary battery according to claim 1, wherein the first lithium-transition metal oxide particles have a median particle diameter (D50) of 2 μm to 4 μm.

8. The cathode active material for a lithium secondary battery according to claim 1, wherein the first lithium-transition metal oxide particles have a uni-modal distribution.

9. The cathode active material for a lithium secondary battery according to claim 1, wherein the median particle diameter (D50) of the small-sized lithium-transition metal oxide particles is smaller than the median particle diameter (D50) of the first lithium-transition metal oxide particles.

10. The cathode active material for a lithium secondary battery according to claim 1, wherein the weight ratio of the second lithium-transition metal oxide particles to the first lithium-transition metal oxide particles is 2 or more.

11. The cathode active material for a lithium secondary battery according to claim 1, wherein the weight ratio of the small-sized lithium-transition metal oxide particles to the large-sized lithium-transition metal oxide particles in the second lithium-transition metal oxide particles is 0.15 to 0.75.

12. The cathode active material for a lithium secondary battery according to claim 1, wherein the first lithium-transition metal oxide particles, the large-sized lithium-transition metal oxide particles, and the small-sized lithium-transition metal oxide particles each independently comprise nickel, manganese and cobalt.

13. The cathode active material for a lithium secondary battery according to claim 1, wherein the first lithium-transition metal oxide particles, the large-sized lithium-transition metal oxide particles, and the small-sized lithium-transition metal oxide particles each independently have a composition represented by Formula 1 below: 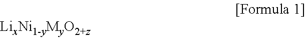
(in Formula 1, 0.9≤x≤1.1, 0<y≤0.7, −0.1≤z≤0.1, Mis one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Ba).

14. The cathode active material for a lithium secondary battery according to claim 12, wherein the molar fraction of nickel among metals excluding lithium in the first lithium-transition metal oxide particles, the large-sized lithium-transition metal oxide particles and the small-sized lithium-transition metal oxide particles is 0.8 or more.

15. The cathode active material for a lithium secondary battery according to claim 1, wherein the large-sized lithium-transition metal oxide particles and the small-sized lithium-transition metal oxide particles each independently have a secondary particle form.

16. A lithium secondary battery comprising:
a cathode comprising the cathode active material for a lithium secondary battery according to claim 1; and
an anode disposed opposite to the cathode.
